(19) United States
(12) Patent Application Publication
(10) Pub. No.: US 2026/0310314 A1
(43) Pub. Date: Oct. 8, 2026

(54) TOUCH DRIVING INTEGRATED CIRCUIT AND OPERATION METHOD THEREOF AND TOUCH DEVICE

(71) Applicant: NOVATEK Microelectronics Corp., Hsinchu (TW)

(72) Inventors: Yi-Wei Chen, Tainan City (TW); Weijen Chang, Tainan City (TW); Yu-Ying Tang, Taoyuan City (TW); Chin-Lin Lee, Hsinchu City (TW)

(73) Assignee: NOVATEK Microelectronics Corp., Hsinchu (TW)

(21) Appl. No.: 19/636,935

(22) Filed: Apr. 2, 2026

Related U.S. Application Data
(60) Provisional application No. 63/782,031, filed on Apr. 2, 2025.

(51) Int. Cl. G06F 3/041; G06F 3/01; G06F 3/0346; G06F 3/0354; G06F 3/038

(52) U.S. Cl. CPC G06F 3/04162; G06F 3/017; G06F 3/0346; G06F 3/03545; G06F 3/0383; G06F 3/0412; G06F 2203/0384

(57) ABSTRACT

Provided is a touch driving integrated circuit (IC), an operation method thereof, and a touch device. The touch driving IC is used to drive a touch panel. The touch driving IC includes a touch interface circuit and an operation circuit. The touch interface circuit is coupled to the touch panel. The touch interface circuit communicates with an active stylus. The operation circuit is coupled to the touch interface circuit. In response to a stylus tip or a stylus tail of the active stylus touching the touch panel, the operation circuit determines a touch position of the active stylus. Based on stylus gesture information, the operation circuit determines whether to perform an eraser operation or a writing operation. The stylus gesture information includes a relative tilt angle between a tilt angle of the active stylus and a tilt angle of the touch panel.

### CROSS-REFERENCE TO RELATED APPLICATION

This application claims the priority benefit of U.S. provisional application serial no. 63/782,031, filed on Apr. 2, 2025. The entirety of the above-mentioned patent application is hereby incorporated by reference herein and made a part of this specification.

### BACKGROUND

### Technical Field

The disclosure relates to a touch technology, and more particularly, to a touch driving integrated circuit, an operation method thereof, and a touch device.

### Description of Related Art

The demand of users for input operations such as writing and drawing on a touch device using a stylus is increasing day by day, and thus various types of stylus (passive stylus or active stylus) products have emerged accordingly. Based on various types of styluses, a touch panel and a touch driving integrated circuit are also required to have corresponding matching functions.

### SUMMARY

The disclosure provides a touch driving integrated circuit, an operation method thereof, and a touch device, so as to accurately trigger an eraser mode.

In an embodiment of the disclosure, the touch driving integrated circuit is used to drive a touch panel. The touch driving integrated circuit includes a touch interface circuit and an operation circuit. The touch interface circuit is configured to be coupled to the touch panel and configured to communicate with an active stylus. The operation circuit is coupled to the touch interface circuit. The operation circuit is configured to determine a touch position of the active stylus in response to a stylus tip or a stylus tail of the active stylus touching the touch panel. The operation circuit determines to perform an eraser operation or a writing operation based on stylus gesture information. The stylus gesture information includes a relative tilt angle between a tilt angle of the active stylus and a tile angle of the touch panel.

In an embodiment of the disclosure, the operation method includes the following. A touch interface circuit of the touch driving integrated circuit communicates with an active stylus. An operation circuit of the touch driving integrated circuit determines a touch position of the active stylus in response to a stylus tip or a stylus tail of the active stylus touching the touch panel. The operation circuit determines to perform an eraser operation or a writing operation based on stylus gesture information. The stylus gesture information includes a relative tilt angle between a tilt angle of the active stylus and a tile angle of the touch panel.

In an embodiment of the disclosure, the touch device includes a system processor, a touch panel, and a touch driving integrated circuit. The touch driving integrated circuit is coupled to the system processor and the touch panel. The touch driving integrated circuit is configured to drive the touch panel, communicate with an active stylus, and perform an eraser operation or a writing operation based on stylus gesture information. The stylus gesture information includes a relative tilt angle between a tilt angle of the active stylus and a tile angle of the touch panel.

Based on the above, the active stylus described in the embodiments of the disclosure may provide the stylus gesture information to the touch driving integrated circuit of the touch device. The operation circuit of the touch driving integrated circuit may process the stylus gesture information to obtain the relative tilt angle between the tilt angle of the active stylus and the tilt angle of the touch panel. Based on the stylus gesture information including the relative tilt angle, the operation circuit may determine to perform a corresponding operation, such as the eraser operation, the writing operation, or other active stylus operations. Therefore, the operation circuit may automatically and accurately trigger the eraser mode for the active stylus.

In order for the aforementioned features and advantages of the disclosure to be more comprehensible, embodiments accompanied with drawings are described in detail below.

### BRIEF DESCRIPTION OF THE DRAWINGS

FIGS. 1A and 1B are schematic diagrams of different operation scenarios of a touch system according to an embodiment of the disclosure.

FIG. 2 is a schematic circuit block diagram of a touch device according to an embodiment of the disclosure.

FIG. 3 is a schematic flowchart of an operation method of a touch driving integrated circuit according to an embodiment of the disclosure.

FIG. 4 is a schematic circuit block diagram of a touch interface circuit and an operation circuit according to an embodiment of the disclosure.

FIG. 5 is a schematic circuit block diagram of a touch device according to another embodiment of the disclosure.

### DETAILED DESCRIPTION OF DISCLOSED EMBODIMENTS

The term “coupling (or connection)” as used throughout the present specification (including the claims) may refer to any direct or indirect connection means. For example, if it is described that a first device is coupled (or connected) to a second device, it should be interpreted that the first device can be directly connected to the second device, or the first device can be indirectly connected to the second device through other devices or a certain connection means. The terms “first”, “second” and the like as mentioned throughout the present specification (including the claims) are used to name the elements or to distinguish between different embodiments or scopes, rather than setting an upper or lower limit on the number of the elements or the order of the elements. In addition, wherever possible, elements/components/steps with the same reference numerals in the drawings and embodiments represent the same or similar parts. Cross-reference may be made between the elements/components/steps in different embodiments that are denoted by the same reference numerals or that have the same names. It should be understood that features of the following embodiments may be combined with each other. For example, the features of the second embodiment may be combined with the features of the first embodiment. A person of ordinary skill in the art may select appropriate combinations of features according to actual design requirements.

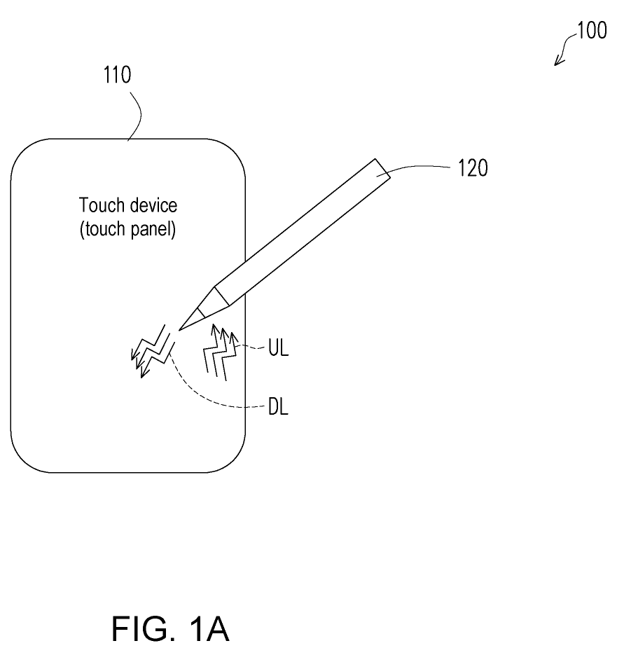

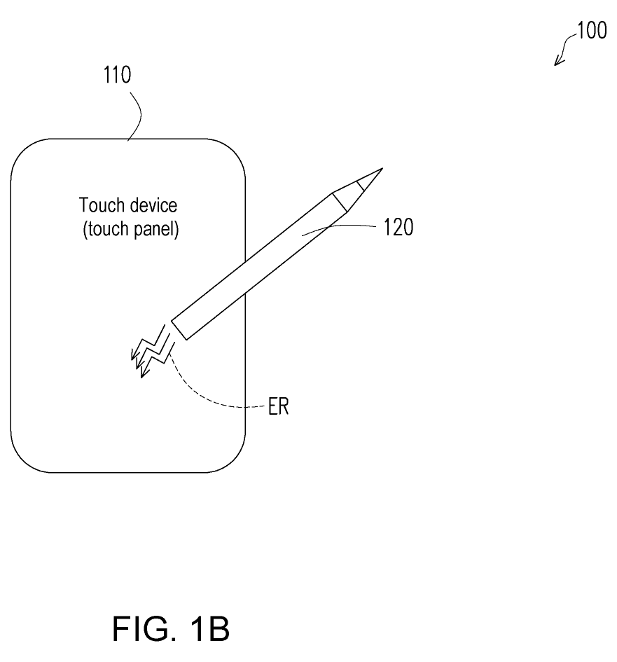

FIGS. 1A and 1B are schematic diagrams of different operation scenarios of a touch system 100 according to an embodiment of the disclosure. The touch system 100 shown in FIGS. 1A and 1B includes a touch device 110 and an active stylus 120. The touch device 110 may detect a touching event occurring on a touch panel. The so-called touching event herein refers to an object (such as an active stylus, a finger, or other objects) directly touching or hovering touching the touch panel.

Based on practical applications and design, a touch panel of the touch device 110 may be integrated with a touch display panel, and a touch driving integrated circuit (IC) of the touch device 110 may include a display driving circuit (not shown). The touch driving integrated circuit may be formed as a touch and display driver integration (TDDI) chip if the display driving circuit (not shown) is embedded in. The display driving circuit is configured to drive the touch display panel to display multiple image frames based on a touch position reported by the active stylus 120. The image frames display a writing trajectory or an erasing trajectory formed by movement of the active stylus 120.

The operation scenario shown in FIG. 1A is that a stylus tip of the active stylus 120 touches (directly touches or hovering touches) the touch panel of the touch device 110. That is, FIG. 1A shows a writing gesture of the active stylus 120. The stylus tip of the active stylus 120 may sense an uplink signal UL transmitted by the touch panel of the touch device 110. Based on the trigger of the uplink signal UL, the stylus tip of the active stylus 120 may transmit a downlink signal DL to the touch panel of the touch device 110. In response to the stylus tip of the active stylus 120 touching the touch panel of the touch device 110, the touch device 110 may sense and determine the touch position of the active stylus 120 on the touch panel. Based on the touch position of the stylus tip of the active stylus 120 on the touch panel, the touch device 110 may perform a writing operation.

The operation scenario shown in FIG. 1B is that a stylus tail of the active stylus 120 touches (directly touches or hovering touches) the touch panel of the touch device 110. That is, FIG. 1B shows an eraser gesture of the active stylus 120. The stylus tail of the active stylus 120 may transmit an eraser signal ER to the touch panel of the touch device 110. Based on practical design and applications, the eraser signal ER may be a DC signal, a ground signal, or other signals. In response to the stylus tail of the active stylus 120 touching the touch panel of the touch device 110, the touch device 110 may sense and determine the touch position of the active stylus 120 on the touch panel. Based on the touch position of the stylus tail of the active stylus 120 on the touch panel, the touch device 110 may perform an eraser operation.

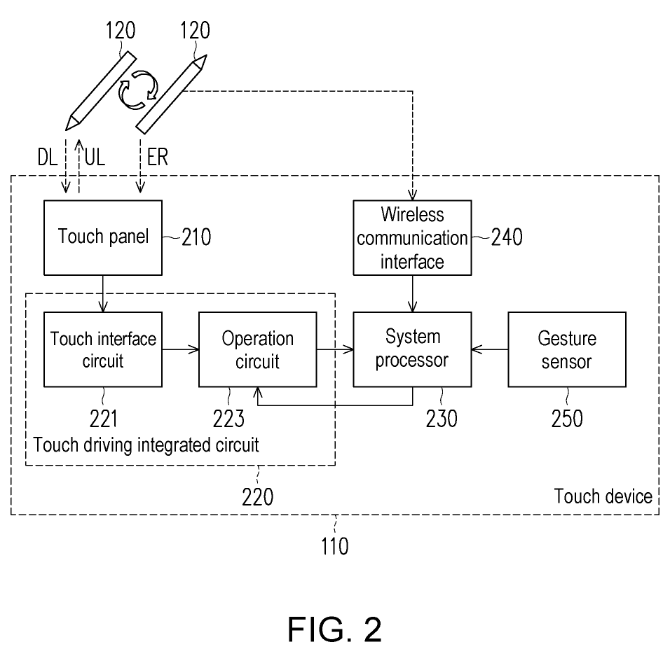

FIG. 2 is a schematic circuit block diagram of the touch device 110 according to an embodiment of the disclosure. The touch device 110 shown in FIG. 2 may serve as one of many embodiments of the touch device 110 shown in FIG. 1. The touch device 110, the active stylus 120, the uplink signal UL, the downlink signal DL, and the eraser signal ER shown in FIG. 2 may refer to the related descriptions in FIG. 1, and thus will not be repeated herein. In the embodiment shown in FIG. 2, the touch device 110 includes a touch panel 210, a touch driving IC 220, a system processor 230, a wireless communication interface 240, and a gesture sensor 250. The touch driving IC 220 is coupled to the system processor 230 and the touch panel 210. The touch driving IC 220 is configured to drive the touch panel 210.

In general, the active stylus 120 is configured with a gesture sensor that is used for measuring a tilt angle of the active stylus 120. Based on practical design and applications, the gesture sensor includes an inertial measurement unit (IMU) or other tilt angle measuring devices. The IMU is also known as a multi-axis motion sensor, which typically integrates multiple sensing elements, for example including an accelerometer, a gyroscope, and a magnetometer. In some application scenarios, the touch driving IC 220 may communicate with the active stylus 120 through the touch panel 210 to obtain information of the tilt angle of the active stylus 120. In other application scenarios, the system processor 230 may receive information of the tilt angle of the active stylus 120 from the active stylus 120 through the wireless communication interface 240 and the touch driving IC 220 may obtain information of the tilt angle of the active stylus 120 from the system processor 230 and also obtain information of a tilt angle of the touch panel 210 from the system processor 230, and the touch driving IC 220 calculates the relative tilt angle between the tilt angle of the active stylus 120 and the tile angle of the touch panel 210. Based on practical design and applications, the wireless communication interface 240 includes a Bluetooth channel or other wireless communication channels. In other application scenarios, the system processor 230 generates the relative tilt angle between the tilt angle of the active stylus 120 and the tile angle of the touch panel 210 and transmits information of the relative tilt angle to the touch driver IC 220, so that the touch driver IC 220 does not need to calculates the relative tilt angle by itself.

In response to the stylus tip or the stylus tail of the active stylus 120 touching the touch panel 210, the touch driving IC 220 may sense and determine the touch position of the active stylus 120 on the touch panel 210. The touch driving IC 220 determines to perform the eraser operation or the writing operation based on the stylus gesture information, wherein stylus gesture information (including information of the relative tilt angle) can be generated by the touch driving IC 220 or by the system processor 230.

Based on the control of the system processor 230, the touch driving IC 220 drives the touch panel 210 to detect the touching event. In the embodiment shown in FIG. 2, the touch driving IC 220 includes a touch interface circuit 221 and an operation circuit 223. The touch interface circuit 221 is coupled to the touch panel 210 and the operation circuit 223, and the operation circuit 223 is coupled to the system processor 230. According to different designs, in some embodiments, the touch driving IC 220, the touch interface circuit 221, the operation circuit 223, and/or the system processor 230 may be implemented as hardware circuits. In other embodiments, the touch driving IC 220, the touch interface circuit 221, the operation circuit 223, and/or the system processor 230 may be implemented as a combination of multiple of hardware, firmware, and software (i.e., programs).

In terms of hardware, the touch driving IC 220, the touch interface circuit 221, the operation circuit 223, and/or the system processor 230 may be implemented as including analog circuits and/or logic circuits on an integrated circuit. For example, relevant functions of the touch driving IC 220, the touch interface circuit 221, the operation circuit 223, and/or the system processor 230 may be implemented in various logic blocks, modules, and circuits in one or more hardware controllers, microcontrollers, hardware processors, microprocessors, application-specific integrated circuits (ASICs), digital signal processors (DSPs), field programmable gate arrays (FPGAs), central processing units (CPUs), and/or other processing units. The relevant functions of the touch driving IC 220, the touch interface circuit 221, the operation circuit 223, and/or the system processor 230 may be implemented as the hardware circuits, such as various logic blocks, modules, and circuits in the integrated circuits, by using hardware description languages (e.g., Verilog HDL or VHDL) or other suitable programming languages.

In terms of hardware and firmware mixing, the relevant functions of the touch driving IC 220, including the touch interface circuit 221 and the operation circuit 223, and/or the system processor 230 may be implemented as including programming codes. For example, the operation circuit 223 and/or the system processor 230 may include blocks implemented by using general programming languages (e.g., C, C++, or assembly language) or other suitable programming languages. The programming codes may be recorded/stored in a “non-transitory machine-readable storage medium”. In some embodiments, the non-transitory machine-readable storage medium includes, for example, a semiconductor memory and/or a storage device. An electronic device (e.g., a computer, a CPU, a hardware controller, a microcontroller, a hardware processor, or a microprocessor) may read and execute the programming codes from the non-transitory machine-readable storage medium, thereby implementing the relevant functions of the touch driving IC 220, the touch interface circuit 221, the operation circuit 223, and/or the system processor 230.

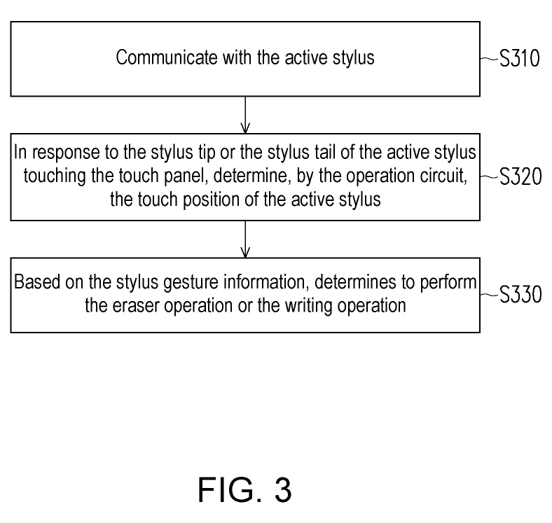

FIG. 3 is a schematic flowchart of an operation method of the touch driving IC 220 according to an embodiment of the disclosure. Referring to FIGS. 2 and 3, in step S310, the touch interface circuit 221 communicates with the active stylus 120 through the touch panel 210. In response to the stylus tip or the stylus tail of the active stylus 120 touching the touch panel 210, the operation circuit 223 determines the touch position of the active stylus 120 (step S320). For example, based on multiple touch sensing data generated by the touch interface circuit 221, the operation circuit 223 determines the touch position of the active stylus 120. The operation circuit 223 may transmit the touch positions of the active stylus 120 to the system processor 230 through a transmission interface (e.g., but not limited to, I2C or SPI).

In some application examples, the active stylus 120 may provide information of the tilt angle of the active stylus 120 to the system processor 230 through the wireless communication interface 240. The system processor 230 may further receive information of the tilt angle of the touch panel 210 (the touch device 110) sensed by the gesture sensor 250. Based on actual design and application, the gesture sensor 250 includes an IMU or other tilt angle measuring devices. The system processor 230 may calculate the relative tilt angle between the tilt angle of the active stylus 120 and the tilt angle of the touch panel 210, which is taken as the stylus gesture information, and then the operation circuit 223 may receive information of the relative tilt angle from the system processor 230 through the transmission interface that the touch position are reported through to the system processor 230. Or, the system processor 230 does not generate the relative tilt angle but transmits information of the tilt angle of the active stylus 120 and information of the tile angle of the touch panel 210 to the touch driver IC 220 through the same transmission interface that the touch positions are reported through to the system processor 230, and the touch driver IC 220 calculates the relative tilt angle between the tilt angle of the active stylus 120 and the tile angle of the touch panel 210.

In yet some other application examples, the information of the tilt angle of the active stylus 120 is carried in stylus downlink signals transmitted from the active stylus 120 to the touch driver IC 220 through the touch panel 210, received by the touch interface circuit 221. The operation circuit 223 receives the information of the tilt angle of the active stylus 120 and the operation circuit 223 receives the information of the tilt angle of the touch panel 210 from the system processor 230. Therefore, the operation circuit 223 may calculate the relative tilt angle between the tilt angle of the active stylus 120 and the tilt angle of the touch panel 210.

In step S330, based on the stylus gesture information that includes the relative tilt angle between the tilt angle of the active stylus 120 and the tilt angle of the touch panel 210, the operation circuit 223 determines to perform the eraser operation or the writing operation regarding the active stylus 120.

For example, in response to the operation circuit 223 determining that the relative tilt angle is in a first range (the first range indicates that the active stylus 120 is in the writing gesture), the operation circuit 223 performs the writing operation. The writing operation includes reporting the touch position of the active stylus 120 and information indicating the writing operation to the system processor 230. The first range may be determined according to actual design and application. For example, the first range may be between +300 degree and +60 degree, and in this range the stylus tip of the active stylus 120 faces toward the touch panel 210, a longitudinal axis direction of the active stylus 120 is about parallel to a normal direction of the touch panel 210, and the relative tilt angle of the active stylus 120 is defined as 0 degree at this time. Otherwise, in response to the operation circuit 223 determining that the relative tilt angle is not in the first range that indicates the active stylus 120 is in the writing gesture, the operation circuit 223 performs the eraser operation. In the eraser operation, the touch interface circuit 221 receives the DC signal or the ground signal that is generated by the stylus tail of the active stylus 120 through the touch panel 210.

In some application examples, the operation circuit 223 may not start the eraser operation until the operation circuit 223 confirms that the active stylus 120 is steadily in the eraser gesture. In other words, in response to the operation circuit 223 determining that the relative tilt angle is not in the first range that indicates the active stylus 120 is in the writing gesture for a predefined number of times which is once or more than once (the predefined number of times is determined according to actual design and application) or for a predefined period of time, the operation circuit 223 performs the eraser operation. The eraser operation includes reporting the touch position of the active stylus 120 and information indicating the eraser operation to the system processor 230. In other application examples, the operation circuit 223 may not start the eraser operation until the operation circuit 223 confirms that the active stylus 120 is indeed in the eraser gesture in a much higher confidence level. For example, in response to the operation circuit 223 determining that the relative tilt angle is not in the first range (i.e., not the writing gesture) and is also in a second range (which means the active stylus 120 is guaranteed in the eraser gesture) for a predefined number of times which is once or more than once (the predefined number of times is determined according to actual design and application) or for a predefined period of time, the operation circuit 223 performs the eraser operation. The first range and the second range do not overlap. The second range may be determined according to actual design and application. For example, the second range may be between +120 degrees and +240 degrees.

In addition, when the operation circuit 223 is performing the eraser operation, the operation circuit 223 may further determine an angle between the active stylus 120 (in the eraser gesture) and a normal of the touch panel 210 according to information of the tilt angle of the active stylus 120 included in the stylus gesture information. The operation circuit 223 reports information of the angle between the active stylus 120 (in the eraser gesture) and the normal of the touch panel 210 to the system processor 230 to determine an erasing area of the eraser operation. Based on a change in the stylus gesture information (including the relative tilt angle or separate tilt angle information that can be used to calculate the relative tilt angle), the system processor 230 may simulate an effect of using an eraser at an end of a general pencil: the more the stylus is tilted, the larger the erasing area of the eraser. That is, the smaller the angle between the active stylus 120 and the normal of the touch panel 210, the smaller the erasing area of the eraser operation; conversely, the larger the angle, the larger the erasing area of the eraser operation.

Based on the stylus gesture information including the relative tilt angle, the operation circuit 223 may determine to perform a corresponding operation, such as the eraser operation, the writing operation, or other active stylus operations. Therefore, the operation circuit 223 may automatically and accurately trigger an eraser mode for the active stylus.

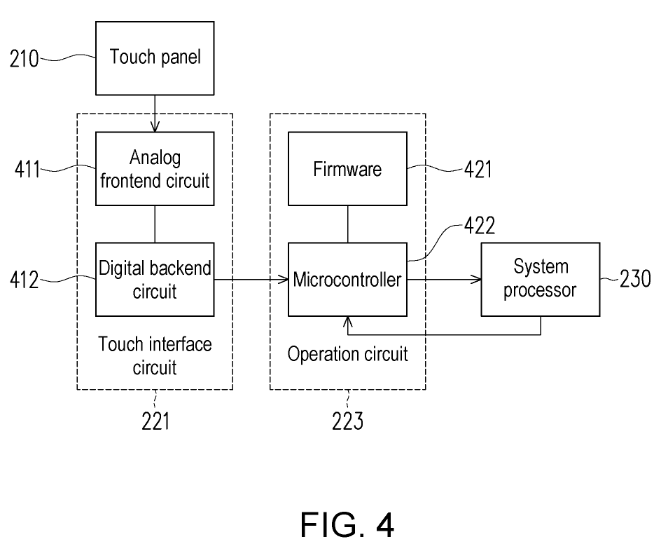

FIG. 4 is a schematic circuit block diagram of the touch interface circuit 221 and the operation circuit 223 according to an embodiment of the disclosure. In the embodiment shown in FIG. 4, the touch interface circuit 221 includes an analog frontend circuit 411 and a digital backend circuit 412. The analog frontend circuit 411 transmits and receives analog sensing signals during an active stylus communication period and converts the analog sensing signals into digital touch sensing data for the digital backend circuit 412. The digital backend circuit 412 analyzes the sensing data to obtain information such as signal strength and signal frequency. The digital backend circuit 412 may determine which sensing electrode the sensing signal comes from receives the downlink signal DL of the active stylus 120, and further decodes the downlink signal DL to obtain a command transmitted by the active stylus 120.

In the embodiment shown in FIG. 4, the operation circuit 223 includes firmware 421 and a microcontroller 422. The microcontroller 422 is coupled to the digital backend circuit 412 to receive touch sensing data. The microcontroller 422 running the firmware 421 may perform related functions of the operation circuit 223 shown in FIG. 2. For example, based on the touch sensing data provided by the digital backend circuit 412 (the touch sensing data of all the sensing electrodes or some of the sensing electrodes on the touch panel 210), the microcontroller 422 running the firmware 421 may calculate the touch position of the active stylus 120.

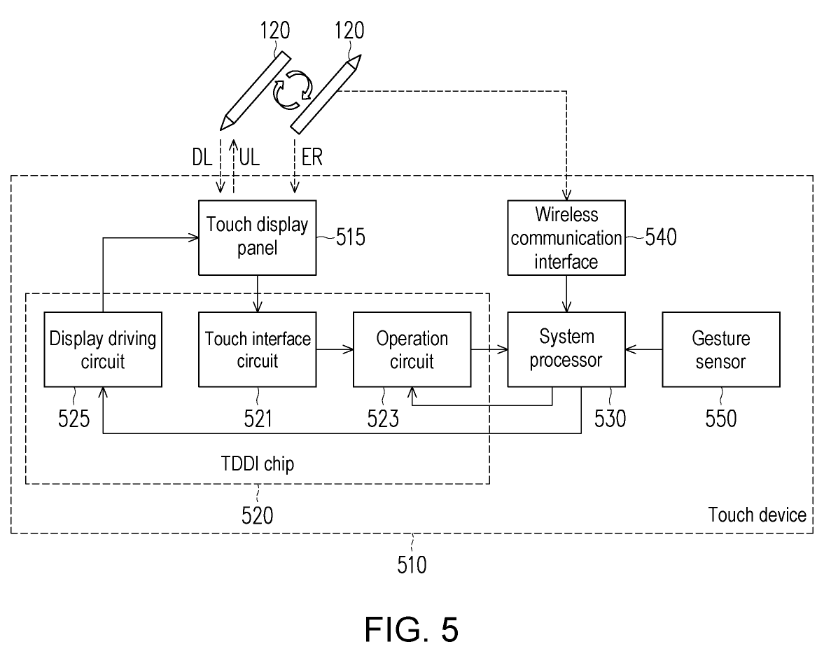

FIG. 5 is a schematic circuit block diagram of a touch device 510 according to another embodiment of the disclosure. The touch device 510 shown in FIG. 5 may serve as one of many embodiments of the touch device 110 shown in FIG. 1. The touch device 510, the active stylus 120, the uplink signal UL, the downlink signal DL, and the eraser signal ER shown in FIG. 5 may refer to the related descriptions in FIG. 1, and thus will not be repeated herein. In the embodiment shown in FIG. 5, the touch device 510 includes a touch display panel 515, a touch and display driver integrated (TDDI) chip 520, a system processor 530, a wireless communication interface 540, and a gesture sensor 550. The touch device 510, the touch display panel 515, the TDDI chip 520, the system processor 530, the wireless communication interface 540, and the gesture sensor 550 shown in FIG. 5 may refer to the related descriptions of the touch device 110, the touch panel 210, the touch driving IC 220, the system processor 230, the wireless communication interface 240, and the gesture sensor 250 shown in FIG. 2 and be analogized accordingly.

In the embodiment shown in FIG. 5, the touch panel of the touch device 510 may be integrated with the touch display panel 515, and the TDDI chip 520 of the touch device 510 may include a touch interface circuit 521, an operation circuit 523, and a display driving circuit 525. The touch interface circuit 521 and the operation circuit 523 shown in FIG. 5 may refer to the related descriptions of the touch interface circuit 221 and the operation circuit 223 shown in FIG. 2 and be analogized accordingly, and thus will not be repeated herein. The display driving circuit 525 is configured to drive the touch display panel 515 to display multiple image frames based on the touch position reported by the active stylus 120. The image frames display the writing trajectory or the erasing trajectory formed by the movement of the active stylus 120.

Based on the above, the touch device assists in determining whether an eraser function of the active stylus is activated based on the relative tilt angle between the active stylus and the touch panel. Based on this, the touch device may avoid erroneously determining the eraser operation.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A touch driving integrated circuit for driving a touch panel, the touch driving integrated circuit comprising:
a touch interface circuit configured to be coupled to the touch panel and configured to communicate with an active stylus; and
an operation circuit coupled to the touch interface circuit, configured to determine a touch position of the active stylus in response to a stylus tip or a stylus tail of the active stylus touching the touch panel and determine to perform an eraser operation or a writing operation based on stylus gesture information, wherein the stylus gesture information comprises a relative tilt angle between a tilt angle of the active stylus and a tile angle of the touch panel.

2. The touch driving integrated circuit according to claim 1, wherein the operation circuit determines the touch position of the active stylus based on a plurality of touch sensing data that are generated by the touch interface circuit.

3. The touch driving integrated circuit according to claim 1, wherein in response to the operation circuit determining that the relative tilt angle is in a first range that indicates the active stylus is in a writing gesture, the operation circuit performs the writing operation comprising to report the touch position of the active stylus and information indicating the writing operation to a system processor.

4. The touch driving integrated circuit according to claim 1, wherein in response to determining that the relative tilt angle is not in a first range that indicates the active stylus is in a writing gesture for a predefined number of times which is once or more than once, the operation circuit performs the eraser operation, comprising to report the touch position of the active stylus and information indicating the eraser operation to a system processor.

5. The touch driving integrated circuit according to claim 1, wherein in response to determining that the relative tilt angle is not in a first range that indicates the active stylus is in a writing gesture and is in a second range that indicates the active stylus is in an eraser gesture for a predefined number of times which is once or more than once, the operation circuit performs the eraser operation, comprising to report the touch position of the active stylus and information indicating the eraser operation to a system processor, wherein the first range is not overlapping with the second range.

6. The touch driving integrated circuit according to claim 1, wherein the touch panel is integrated with a touch display panel, and the touch driving integrated circuit further comprises:
a display driving circuit formed as a touch and display driver integration chip, wherein the display driving circuit is configured to drive the touch display panel to display image frames that display a writing trajectory or an erasing trajectory formed based on the reported touch positions of the active stylus.

7. The touch driving integrated circuit according to claim 1, wherein the writing operation is performed when the relative tilt angle falls within a first range that indicates the active stylus is making a writing gesture, and the eraser operation is performed when the relative tilt angle falls within a second range that indicates the active stylus is making an eraser gesture, and the first range and the second range do not overlap.

8. The touch driving integrated circuit according to claim 1, wherein the touch interface circuit receives a DC signal or a ground signal from the touch panel when the operation circuit performs the eraser operation.

9. The touch driving integrated circuit according to claim 1, wherein the operation circuit receive information of the relative tilt angle from a system processor.

10. The touch driving integrated circuit according to claim 1, wherein the operation circuit receives information of the tilt angle of the active stylus and information of the tilt angle of the touch panel from a system processor, and the operation circuit calculates the relative tilt angle.

11. The touch driving integrated circuit according to claim 10, wherein the information of the tilt angle of the active stylus is transmitted from the active stylus to the system processor through a wireless communication interface.

12. The touch driving integrated circuit according to claim 1, wherein the operation circuit receives information of the tilt angle of the active stylus from the active stylus, and receives information of the tilt angle of the touch panel from a system processor, and the operation circuit calculates the relative tilt angle.

13. The touch driving integrated circuit according to claim 1, wherein the operation circuit determines an angle between the active stylus and a normal of the touch panel based on a tilt angle information comprised in the stylus gesture information.

14. The touch driving integrated circuit according to claim 13, wherein the operation circuit reports information of the angle between the active stylus and the normal of the touch panel to a system processor, for determining an erasing area of the eraser operation.

15. An operation method of a touch driving integrated circuit for driving a touch panel, the operation method comprising:
communicating with an active stylus by a touch interface circuit of the touch driving integrated circuit, wherein the touch interface circuit is coupled to the touch panel;
determining a touch position of the active stylus by an operation circuit of the touch driving integrated circuit in response to a stylus tip or a stylus tail of the active stylus touching the touch panel, wherein the operation circuit is coupled to the touch interface circuit; and
determining to perform an eraser operation or a writing operation by the operation circuit based on stylus gesture information, wherein the stylus gesture information comprises a relative tilt angle between a tilt angle of the active stylus and a tile angle of the touch panel.

16. The operation method according to claim 15, further comprising:
determining the touch position of the active stylus by the operation circuit based on a plurality of touch sensing data that are generated by the touch interface circuit.

17. The operation method according to claim 15, further comprising:
in response to the operation circuit determining that the relative tilt angle is in a first range that indicates the active stylus is in a writing gesture, performing the writing operation comprising to report the touch position of the active stylus and information indicating the writing operation to a system processor.

18. The operation method according to claim 15, further comprising:
in response to determining that the relative tilt angle is not in a first range that indicates the active stylus is in a writing gesture for a predefined number of times which is once or more than once, performing the eraser operation, comprising to report the touch position of the active stylus and information indicating the eraser operation to a system processor.

19. The operation method according to claim 15, further comprising:
in response to determining that the relative tilt angle is not in a first range that indicates the active stylus is in a writing gesture and is in a second range that indicates the active stylus is in an eraser gesture for a predefined number of times which is once or more than once, performing the eraser operation, comprising to report the touch position of the active stylus and information indicating the eraser operation to a system processor, wherein the first range is not overlapping with the second range.

20. The operation method according to claim 15, wherein the touch panel is integrated with a touch display panel, and the touch driving integrated circuit further comprises a display driving circuit formed as a touch and display driver integration chip, and the display driving circuit is configured to drive the touch display panel to display image frames that display a writing trajectory or an erasing trajectory formed based on the reported touch positions of the active stylus.

21. The operation method according to claim 15, wherein the writing operation is performed when the relative tilt angle falls within a first range that indicates the active stylus is making a writing gesture, and the eraser operation is performed when the relative tilt angle falls within a second range that indicates the active stylus is making an eraser gesture, and the first range and the second range do not overlap.

22. The operation method according to claim 15, further comprising:
receiving a DC signal or a ground signal from the touch panel by the touch interface circuit when the operation circuit performs the eraser operation.

23. The operation method according to claim 15, further comprising:
receiving information of the relative tilt angle from a system processor by the operation circuit.

24. The e operation method according to claim 15, further comprising:
receiving, by the operation circuit, information of the tilt angle of the active stylus and information of the tilt angle of the touch panel from a system processor; and
calculating the relative tilt angle by the operation circuit.

25. The operation method according to claim 24, further comprising:
transmitting the information of the tilt angle of the active stylus from the active stylus to the system processor through a wireless communication interface.

26. The operation method according to claim 15, further comprising:
receiving, by the operation circuit, information of the tilt angle of the active stylus from the active stylus;
receiving, by the operation circuit, information of the tilt angle of the touch panel from a system processor; and
calculating the relative tilt angle by the operation circuit.

27. The operation method according to claim 15, further comprising:
determining an angle between the active stylus and the normal of the touch panel by the operation circuit based on a tilt angle information comprised in the stylus gesture information.

28. The operation method according to claim 27, further comprising:
reporting information of the angle between the active stylus and the normal of the touch panel to a system processor, for determining an erasing area of the eraser operation.

29. A touch device comprising:
a system processor;
a touch panel; and
a touch driving integrated circuit coupled to the system processor and the touch panel, wherein the touch driving integrated circuit is configured to drive the touch panel, communicate with an active stylus, and perform an eraser operation or a writing operation based on stylus gesture information, wherein the stylus gesture information comprises a relative tilt angle between a tilt angle of the active stylus and a tile angle of the touch panel.

30. The touch device according to claim 29, wherein the touch driving integrated circuit comprises:
a touch interface circuit configured to be coupled to the touch panel and configured to communicate with the active stylus; and
an operation circuit coupled to the touch interface circuit, configured to determine a touch position of the active stylus in response to a stylus tip or a stylus tail of the active stylus touching the touch panel and determine to perform the eraser operation or the writing operation based on the stylus gesture information.

31. The touch device according to claim 30, wherein the operation circuit determines the touch position of the active stylus based on a plurality of touch sensing data that are generated by the touch interface circuit.

32. The touch device according to claim 30, wherein in response to the operation circuit determining that the relative tilt angle is in a first range that indicates the active stylus is in a writing gesture, the operation circuit performs the writing operation comprising to report the touch position of the active stylus and information indicating the writing operation to the system processor.

33. The touch device according to claim 30, wherein in response to determining that the relative tilt angle is not in a first range that indicates the active stylus is in a writing gesture for a predefined number of times which is once or more than once, the operation circuit performs the eraser operation, comprising to report the touch position of the active stylus and information indicating the eraser operation to the system processor.

34. The touch device according to claim 30, wherein in response to determining that the relative tilt angle is not in a first range that indicates the active stylus is in a writing gesture and is in a second range that indicates the active stylus is in an eraser gesture for a predefined number of times which is once or more than once, the operation circuit performs the eraser operation, comprising to report the touch position of the active stylus and information indicating the eraser operation to the system processor, wherein the first range is not overlapping with the second range.

35. The touch device according to claim 30, wherein the touch panel is integrated with a display panel and the touch driving integrated circuit further comprises:
a display driving circuit formed as a touch and display driver integration chip, and the display driving circuit is configured to drive the touch display panel to display image frames that display a writing trajectory or an erasing trajectory formed based on the reported touch positions of the active stylus.

36. The touch device according to claim 30, wherein the writing operation is performed when the relative tilt angle falls within a first range that indicates the active stylus is making a writing gesture and the eraser operation is performed when the relative tilt angle falls within a second range that indicates the active stylus is making an eraser gesture, and the first range and the second range do not overlap.

37. The touch device according to claim 30, wherein the touch interface circuit receives a DC signal or a ground signal from the touch panel when the operation circuit performs the eraser operation.

38. The touch device according to claim 30, wherein the operation circuit receive information of the relative tilt angle from the system processor.

39. The touch device according to claim 30, wherein the operation circuit receives information of the tilt angle of the active stylus and information of the tilt angle of the touch panel from the system processor, and the operation circuit calculates the relative tilt angle.

40. The touch device according to claim 39, wherein the information of the tilt angle of the active stylus is transmitted from the active stylus to the system processor through a wireless communication interface.

41. The touch device according to claim 30, wherein the operation circuit receives information of the tilt angle of the active stylus from the active stylus, receives information of the tilt angle of the touch panel from the system processor, and the operation circuit calculates the relative tilt angle.

42. The touch device according to claim 30, wherein the operation circuit determines an angle between the active stylus and a normal of the touch panel based on a tilt angle information comprised in the stylus gesture information.

43. The touch device according to claim 42, wherein the operation circuit reports information of the angle between the active stylus and the normal of the touch panel to the system processor, for determining an erasing area of the eraser operation.
